(19) United States
(12) Patent Application Publication
(10) Pub. No.: US 2026/0349826 A1
(43) Pub. Date: Nov. 5, 2026

(54) SYSTEM AND METHOD TO IMPROVE POWER AND MEM LATENCY

(71) Applicant: QUALCOMM Incorporated, San Diego, CA (US)

(72) Inventors: Sumit Gemini, Delhi (IN); Yonghai Huang, Shanghai (CN); Nikhil Kumar Kansal, San Diego, CA (US); Surya Prakash, Hyderabad (IN)

(21) Appl. No.: 19/579,334

(22) PCT Filed: Dec. 22, 2023
(86) PCT No.: PCT/CN2023/140937

§ 371 Date: Apr. 16, 2026

(51) Int. Cl. G06F 9/50

(52) U.S. Cl. CPC G06F 9/505; G06F 9/5016; G06F 9/5094

(57) ABSTRACT

This disclosure provides systems, methods, and devices for memory systems that support enhanced processing core scheduling schemes. In a first aspect, a wireless communication device includes a processing system and a memory coupled to the processing system. The processing system is configured to cause the device to: receive core workload information and cache miss information for one or more cores of the processing system; and adjust which cores to use based on the core workload information and the cache miss information. Other aspects and features are also claimed and described.

### TECHNICAL FIELD

Aspects of the present disclosure relate generally to an apparatus and method for controlling processing cores of a multiple core processing system. Some aspects may, more particularly, relate to an apparatus and method for controlling scheduling operations of a multiple core processing system to support core activation or core switching based on cache miss information to reduce overall power consumption and memory latency.

### INTRODUCTION

As the value and use of information continues to increase, individuals and businesses seek additional ways to process and store information. In addition, the use of information in various locations and desired portability of information is increasing. For this reason, users are increasingly turning towards the use of portable electronic devices, such as mobile phones, digital cameras, laptop computers and the like. Portable electronic devices generally employ a processing system having multiple processing cores to efficiently process data while reducing power consumption.

Some multiple core processing systems may include multiple different types of processing cores which are designed for different operations or situations. For example, the processing system may have low power cores, high performance, cores suited to particular tasks, such as computation or encoding. A scheduler or core controller of the processing system may distribute tasks between the cores to balance workload across the cores and may activate or deactivate the cores based on CPU workload and/or a performance state (e.g., regular or reduced power consumption modes).

### BRIEF SUMMARY OF SOME EXAMPLES

The following summarizes some aspects of the present disclosure to provide a basic understanding of the discussed technology. This summary is not an extensive overview of all contemplated features of the disclosure and is intended neither to identify key or critical elements of all aspects of the disclosure nor to delineate the scope of any or all aspects of the disclosure. Its sole purpose is to present some concepts of one or more aspects of the disclosure in summary form as a prelude to the more detailed description that is presented later.

Aspects disclosed herein describe core control logic for multiple core processing systems, such as processing system with different types of processing cores. As an illustrative example, big. LITTLE processing architecture include big cores and little cores, often refereed to as silver cores and gold cores. When reducing power consumption or balancing power and performance, core control logic, often referred to as a scheduler, may activate cores, deactivate cores, and/or migrate tasks to balance workload and prevent bottlenecks. The scheduler often uses core workload information to determine how to schedule tasks for the cores. In the aspects disclosed herein, the scheduler further considers cache miss rate information for determining how to schedule tasks for and manage the cores. Utilizing cache miss rate information may enable the scheduler to determine if a bottleneck is due to CPU workload alone, or if the bottleneck is due to cache miss or latency issues. If the bottleneck is due in part to cache miss or latency issues, the scheduler can take more appropriate scheduling actions to resolve the cache related bottleneck issues as opposed just adding more processing capacity which may not resolve the bottleneck.

In one aspect of the disclosure, a wireless communication device includes: a processing system; and a memory coupled to the processing system, wherein the processing system is configured to cause the device to: receive core workload information and cache miss information for one or more cores of the processing system; and adjust which cores to use based on the core workload information and the cache miss information.

The foregoing has outlined rather broadly the features and technical advantages of examples according to the disclosure in order that the detailed description that follows may be better understood. Additional features and advantages will be described hereinafter. The conception and specific examples disclosed may be readily utilized as a basis for modifying or designing other structures for carrying out the same purposes of the present disclosure. Such equivalent constructions do not depart from the scope of the appended claims. Characteristics of the concepts disclosed herein, both their organization and method of operation, together with associated advantages will be better understood from the following description when considered in connection with the accompanying figures. Each of the figures is provided for the purposes of illustration and description, and not as a definition of the limits of the claims.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, aspects and/or uses may come about via integrated chip implementations and other non-module-component based devices (e.g., end-user devices, vehicles, communication devices, computing devices, industrial equipment, retail/purchasing devices, medical devices, artificial intelligence (AI)-enabled devices, etc.). While some examples may or may not be specifically directed to use cases or applications, a wide assortment of applicability of described innovations may occur. Implementations may range in spectrum from chip-level or modular components to non-modular, non-chip-level implementations and further to aggregate, distributed, or original equipment manufacturer (OEM) devices or systems incorporating one or more aspects of the described innovations. In some practical settings, devices incorporating described aspects and features may also necessarily include additional components and features for implementation and practice of claimed and described aspects. For example, transmission and reception of wireless signals necessarily includes a number of components for analog and digital purposes (e.g., hardware components including antenna, radio frequency (RF)-chains, power amplifiers, modulators, buffer, processor(s), interleaver, adders/summers, etc.). It is intended that innovations described herein may be practiced in a wide variety of devices, chip-level components, systems, distributed arrangements, end-user devices, etc. of varying sizes, shapes, and constitution.

### BRIEF DESCRIPTION OF THE DRAWINGS

A further understanding of the nature and advantages of the present disclosure may be realized by reference to the following drawings. In the appended figures, similar components or features may have the same reference label. Further, various components of the same type may be distinguished by following the reference label by a dash and a second label that distinguishes among the similar components. If just the first reference label is used in the specification, the description is applicable to any one of the similar components having the same first reference label irrespective of the second reference label.

FIG. 1 is a block diagram illustrating a data processing system including a memory system in accordance with an embodiment of the present invention.

FIG. 2 is a block diagram illustrating an example electronic device including the processing system according to one or more aspects of the disclosure.

FIG. 3 is a block diagram of an embodiment of a system comprising a multi-cluster heterogeneous processor architecture that includes a processor scheduler and a cache scheduler for providing enhanced processing core scheduling schemes for determining active cores based on cache miss rate information according to some aspects of the disclosure.

FIG. 4 is a flow diagram illustrating a method for enhanced processing core scheduling schemes for determining active cores of a multiple core processor based on cache miss rate information according to some aspects of the disclosure.

FIG. 5 is a block diagram illustrating an example of a system that supports enhanced processing core scheduling schemes for determining active cores of a multiple core processor based on cache miss rate information according to some aspects of the disclosure.

FIGS. 6A and 6B are each a block diagram illustrating an example of processing core adjustments of the enhanced processing core scheduling schemes described herein and according to some aspects of the disclosure.

FIG. 7 is a flow chart illustrating a method for an enhanced processing core scheduling scheme for determining active cores of a multiple core processor based on cache miss rate information according to some aspects of the disclosure.

FIG. 8 is a block diagram illustrating details of an example wireless communication system according to one or more aspects of the disclosure.

Like reference numbers and designations in the various drawings indicate like elements.

### DETAILED DESCRIPTION

The detailed description set forth below, in connection with the appended drawings, is intended as a description of various configurations and is not intended to limit the scope of the disclosure. Rather, the detailed description includes specific details for the purpose of providing a thorough understanding of the inventive subject matter. It will be apparent to those skilled in the art that these specific details are not required in every case and that, in some instances, well-known structures and components are shown in block diagram form for clarity of presentation.

The present disclosure provides systems, apparatus, methods, and computer-readable media that support data processing, including techniques for scheduling cores of a multiple core processing system. Aspects of this disclosure provide for operations and logic used in those operations for enhanced core scheduling schemes for adjusting cores and/or core workload based on cache usage information, such as cache miss rate. For example, a scheduler of a multiple core processing system may adjust cores based on core workload and cache usage information for the cores to better identify bottlenecks. To illustrate, a bottleneck may be caused by lack of processing resources (e.g., processing circuitry) or due to cache latency (e.g., processing circuitry waiting on information for computation). These different causes for bottlenecks are not determinable based on CPU usage information alone and the bottlenecks can be more appropriately mitigated if the true or root cause of the bottleneck is known. The aspects of the disclosure enable core switching or core activation based on core workload and cache usage information. For example, core workload and cache usage information may be compared to corresponding thresholds.

Particular implementations of the subject matter described in this disclosure may be implemented to realize one or more of the following potential advantages or benefits. In some aspects, the present disclosure provides techniques for improved performance of a processing system, such as improved throughput and reduced power consumption.

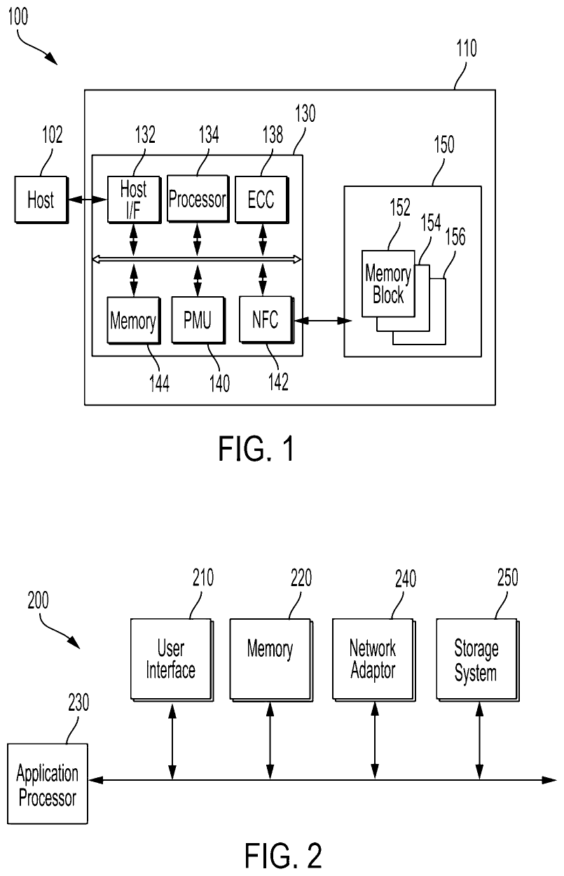

FIG. 1 illustrates a data processing system 100, such as may be included in a mobile computing device, according to one or more aspects of the disclosure. A memory system 110 may couple to a host device 102 through one or more channels. For example, the host device 102 and memory system 110 may be coupled through a serial interface including a single channel for the transport of data or a parallel interface including two or more channels for the transport of data. In some aspects, control data may be transferred through the same channel(s) as the data or the control data may be transferred through additional channels. The host device 102 may be, for example, a portable electronic device such as a mobile phone, an MP3 player, a laptop computer, or a non-portable electronic device such as a desktop computer, a game player, a television (TV), a media player, or a projector. As another example, the host device 102 may be an automotive computer system. In some examples, the memory system 110 may be included in the host device 102. Thus, the data processing system 100 may be any of the example host devices described herein including the memory system 110.

The memory system 110 may execute operations in response to commands (e.g., a request) from the host device 102. For example, the memory system 110 may store data provided by the host device 102 and the memory system 110 may also provide stored data to the host device 102. The memory system 110 may be used as a main memory, short-term memory, or long-term memory by the host device 102. As one example of main memory, the host device 102 may use the memory system 110 to supplement or replace a system memory by using the memory system 110 to store temporary data such as data relating to operating systems and/or threads executing in the operation system. As one example of short-term memory, the host device 102 may use the memory system 110 to store a page file for an operating system. As one example of long-term memory, the host device 102 may use the memory system 110 to store user files (e.g., documents, videos, pictures) and/or application files (e.g., word processing executable, gaming application).

The memory system 110 may be implemented with any one of various storage devices, according to the protocol of a host interface for the one or more channels coupling the memory system 110 to the host device 102. The memory system 110 may be implemented with any one of various storage devices, such as a solid state drive (SSD), a multimedia card (MMC), an embedded MMC (eMMC), a reduced size MMC (RS-MMC), a micro-MMC, a secure digital (SD) card, a mini-SD, a micro-SD, a universal serial bus (USB) storage device, a universal flash storage (UFS) device, a compact flash (CF) card, a smart media (SM) card, or a memory stick.

The memory system 110 may include a memory module 150 and a controller 130 coupled to the memory module 150 through one or more channels. The memory module 150 may store and retrieve data in memory blocks 152, 154, and 156 under control of the controller 130, which may execute commands received from the host device 102. The controller 130 is configured to control data exchange between the memory module 150 and the host device 102. The storage components, such as memory blocks 152, 154, and 156 in the memory module 150 may be implemented as volatile memory device, such as, a dynamic random access memory (DRAM) and a static random access memory (SRAM), or a non-volatile memory device, such as a read only memory (ROM), a programmable ROM (PROM), an erasable programmable ROM (EPROM), an electrically erasable programmable ROM (EEPROM), a ferroelectric random access memory (FRAM), a phase-change RAM (PRAM), a magnetoresistive RAM (MRAM), a resistive RAM (SCRAM), or a NAND flash memory.

The controller 130 and the memory module 150 may be formed as integrated circuits on one or more semiconductor dies (or other substrate). In some aspects, the controller 130 and the memory module 150 may be integrated into one chip. In some aspects, the memory module 150 may include one or more chips coupled in series or parallel with each other and coupled to the controller 130, which is on a separate chip. In some aspects, the memory module 150 and controller 130 chips are integrated in a single package, such as in a package on package (PoP) system. In some aspects, the memory system 110 is integrated on a single chip with one or more or all of the components (e.g., application processor, system memory, digital signal processor, modem, graphics processor unit, memory interface, input/output interface, network adaptor) of the host device 102, such as in a system on chip (SoC). The controller 130 and the memory module 150 may be integrated into one semiconductor device to form a memory card, such as, for example, a Personal Computer Memory Card International Association (PCMCIA) card, a compact flash (CF) card, a smart media card (SMC), a memory stick, a multimedia card (MMC), an RS-MMC, a micro-MMC, a secure digital (SD) card, a mini-SD, a micro-SD, an SDHC, and a universal flash storage (UFS) device.

The controller 130 of the memory system 110 may control the memory module 150 in response to commands from the host device 102. The controller 130 may execute read commands to provide the data from the memory module 150 to the host device 102. The controller 130 may execute write commands to store data provided from the host device 102 into the memory module 150. The controller 130 may execute other commands to manage data in the memory module 150, such as program and erase commands. The controller 130 may also execute other commands to manage control of the memory system 110, such as setting configuration registers of the memory system 110. By executing commands in accordance with the configuration specified in the configuration registers, the controller 130 may control operations of the memory module 150, such as read, write, program, and erase operations.

The controller 130 may include several components configured for performing the received commands. For example, the controller 130 may include a host interface (I/F) unit 132, a processor 134, an error correction code (ECC) unit 138, a power management unit (PMU) 140, a NAND flash controller (NFC) 142, and/or a memory 144. The power management unit (PMU) 140 may provide and manage power for components within the controller 130 and/or the memory module 150.

The host IF unit 132 may process commands and data provided from the host device 102, and may communicate with the host device 102, through at least one of various interface protocols such as universal serial bus (USB), multimedia card (MMC), peripheral component interconnect express (PCI-e), serial attached SCSI (SAS), serial advanced technology attachment (SATA), parallel advanced technology attachment (PATA), small computer system interface (SCSI), enhanced small disk interface (ESDI), and integrated drive electronics (IDE). For example, the host IF unit 132 may be a parallel interface such as an MMC interface, or a serial interface such as an ultra-high speed class 1 (UHS-I)/UHS class 2 (UHS-II) or a universal flash storage (UFS) interface.

The ECC unit 138 may detect and correct errors in the data read from the memory module 150 during the read operation. The ECC unit 138 may not correct error bits when the number of the error bits is greater than a threshold number of correctable error bits, which may result in the ECC unit 138 outputting an error correction fail signal indicating failure in correcting the error bits. In some aspects, no ECC unit 138 may be provided or the ECC unit 138 may be configurable to be active for some or all of the memory module 150. The ECC unit 138 may perform an error correction operation using a coded modulation such as a low-density parity check (LDPC) code, a Bose-Chaudhuri-Hocquenghem (BCH) code, a turbo code, a Reed-Solomon (RS) code, a convolution code, a recursive systematic code (RSC), a trellis-coded modulation (TCM), or a Block coded modulation (BCM).

The NFC 142 provides an interface between the controller 130 and the memory module 150 to allow the controller 130 to control the memory module 150 in response to a commands received from the host device 102. The NFC 142 may generate control signals for the memory module 150, such as signals for rowlines and bitlines, and process data under the control of the processor 134. Although NFC 142 is described as a NAND flash controller, other controllers may perform similar function for other memory types used as memory module 150.

The memory 144 may serve as a working memory of the memory system 110 and the controller 130. The memory 144 may store data for driving the memory system 110 and the controller 130. When the controller 130 controls an operation of the memory module 150 such as, for example, a read, write, program or erase operation, the memory 144 may store data which are used by the controller 130 and the memory module 150 for the operation. The memory 144 may be implemented with a volatile memory such as, for example, a static random access memory (SRAM) or a dynamic random access memory (DRAM). In some aspects, the memory 144 may store address mappings, a program memory, a data memory, a write buffer, a read buffer, a map buffer, and the like.

The processor 134 may control the general operations of the memory system 110, and a write operation or a read operation for the memory module 150, in response to a write request or a read request received from the host device 102, respectively. For example, the processor 134 may execute firmware, which may be referred to as a flash translation layer (FTL), to control the general operations of the memory system 110. The processor 134 may be implemented, for example, with a microprocessor or a central processing unit (CPU), or an application-specific integrated circuit (ASIC).

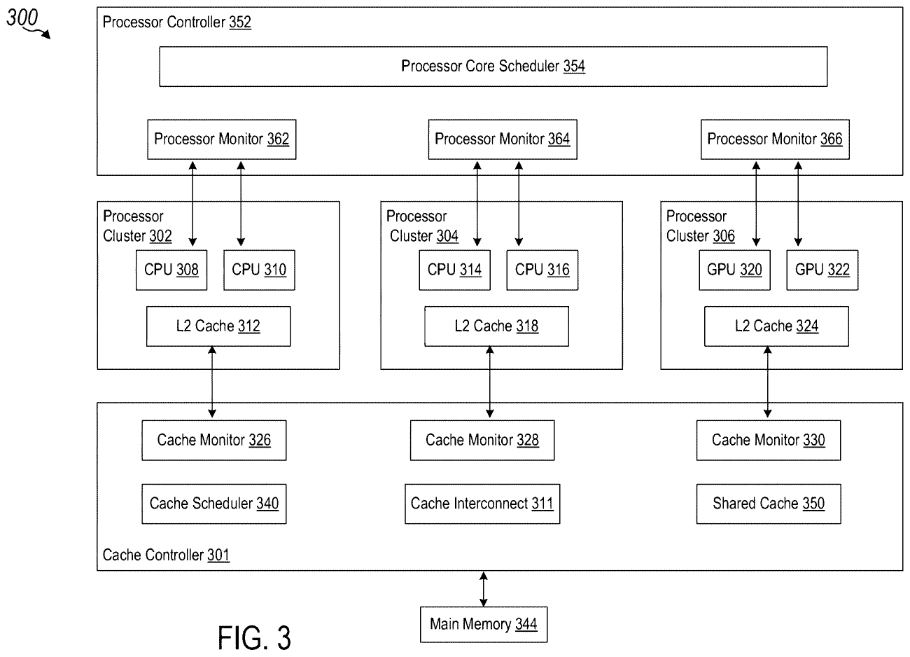

FIG. 2 is a block diagram illustrating an example electronic device including the data processing system 100 according to one or more aspects of the disclosure. The electronic device 200 may include a user interface 210, a memory 220, an application processor 230, a network adaptor 240, and a storage system 250 (which may be one embodiment of the data processing system 100 of FIG. 1). The application processor 230 may be coupled to the other components through a bus, such as a peripheral component interface (PCI) bus, including a PCI express (PCIe) bus.

The application processor 230 may execute computer program code, including applications, drivers, and operating systems, to coordinate performing of tasks by components included in the electronic device 200. For example, the application processor 230 may execute a storage driver for accessing the storage system 250. The application processor 230 may be part of a system-on-chip (SoC) that includes one or more other components shown in electronic device 200.

The memory 220 may operate as a main memory, a working memory, a buffer memory or a cache memory of the electronic device 200. The memory 220 may include a volatile random access memory such as a dynamic random access memory (DRAM), a synchronous dynamic random access memory (SDRAM), a double data rate (DDR) SDRAM, a DDR2 SDRAM, a DDR3 SDRAM, a low power double data rate (LPDDR) SDRAM, an LPDDR2 SDRAM, an LPDDR3 SDRAM, an LPDDR4 SDRAM, an LPDDR5 SDRAM, or an LPDDR6 SDRAM, or a nonvolatile random access memory such as a phase change random access memory (PRAM), a resistive random access memory (ReRAM), a magnetic random access memory (MRAM) and a ferroelectric random access memory (FRAM). In some aspects, the application processor 230 and the memory 220 may be combined using a package-on-package (POP).

The network adaptor 240 may communicate with external devices. For example, the network adaptor 240 may support wired communications and/or various wireless communications such as code division multiple access (CDMA), global system for mobile communication (GSM), wideband CDMA (WCDMA), CDMA-2000, time division multiple access (TDMA), long term evolution (LTE), worldwide interoperability for microwave access (WiMAX), wireless local area network (WLAN), ultra-wideband (UWB), Bluetooth, wireless display (Wi-Di), and so on, and may thereby communicate with wired and/or wireless electronic appliances, for example, a mobile electronic appliance.

The storage system 250 may store data, for example, data received from the application processor 230, and transmit data stored therein, to the application processor 230. The storage system 250 may be a non-volatile semiconductor memory device, such as a phase-change RAM (PRAM), a magnetic RAM (MRAM), a resistive RAM (ReRAM), a NAND flash memory, a NOR flash memory, or a 3-dimensional (3-D) NAND flash memory. The storage system 250 may be a removable storage medium, such as a memory card or an external drive. For example, the storage system 250 may correspond to the memory system 110 described above with reference to FIG. 1 and may be a SSD, eMMC, UFS, or other flash memory system.

The user interface 210 provide one or more graphical user interfaces (GUIs) for inputting data or commands to the application processor 230 or for outputting data to an external device. For example, the user interface 210 may include user input interfaces, such as a virtual keyboard, a touch screen, a camera, a microphone, a gyroscope sensor, or a vibration sensor, and user output interfaces, such as a liquid crystal display (LCD), an organic light emitting diode (OLED) display device, an active matrix OLED (AMOLED) display device, a light emitting diode (LED), a speaker, or a haptic motor.

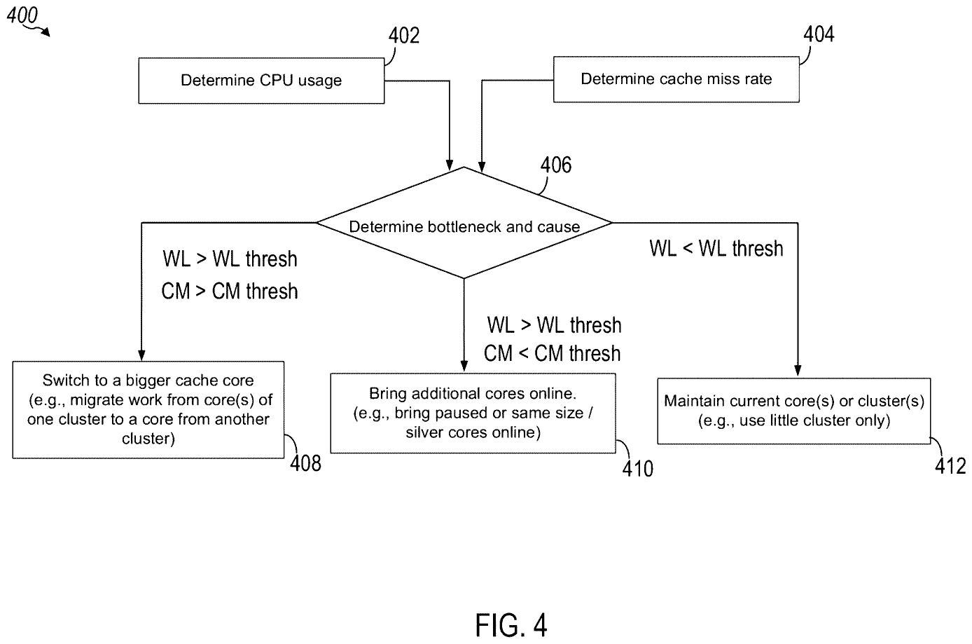

FIG. 3 is a block diagram of an embodiment of a system 300 comprising a multi-cluster heterogeneous processor architecture according to some embodiments of the disclosure. The system 300 may be implemented in any computing device, including a personal computer, a workstation, a server, a portable computing device (PCD), such as a cellular telephone, a portable digital assistant (PDA), a portable game console, a palmtop computer, or a tablet computer. The multi-cluster heterogeneous processor architecture comprises a plurality of processor clusters coupled to a cache controller 301. As known in the art, each processor cluster may comprise one or more processors or processor cores (e.g., central processing unit (CPU), graphics processing unit (GPU), digital signal processor (DSP), etc.) with a corresponding dedicated cache.

In the embodiment of FIG. 3, the processor clusters 302 and 304 may comprise a “big. LITTLE” heterogeneous architecture, as described above, in which the processor cluster 302 comprises a Little cluster and the processor cluster 304 comprises a Big cluster. The Little processor cluster 302 comprises a plurality of central processing unit (CPU) cores 308 and 310 which are relatively slower and consume less power than the CPU cores 314 and 316 in the Big processor cluster 304. The Big cluster CPU cores 314 and 316 may be distinguished from the Little cluster CPU cores 308 and 310 by, for example, a relatively higher instructions per cycle (IPC), higher operating frequency, and/or having a micro-architectural feature that enables relatively more performance but at the cost of additional power. Furthermore, additional processor clusters may be included in the system 300, such as, for example, a processor cluster 306 comprising GPU cores 320 and 322, machine learning cores, etc.

Processor clusters 302, 304, and 306 may have independent cache memory used by the corresponding processors in the system 300 to reduce the average time to access data from a main memory 344. In an embodiment, the independent cache memory and the main memory 344 may be organized as a hierarchy of cache levels (e.g., level one (L1), level two (L2), level three (L3), etc.). Processor cluster 302 may comprise L2 cache 312, processor cluster 304 may comprise L2 cache 318, and processor cluster 306 may comprise L2 cache 324. L1 cache (not shown and optionally part of the CPU) and L2 cache may correspond to dedicated cache. The processor cores and/or clusters may also have shared cache, such as L3 cache and higher, which may be shared between multiple cores and/or clusters. As illustrated in FIG. 3, the cores of a cluster may share a portion or all of shared cached 350.

As illustrated in FIG. 3, the cache controller 301 may comprise a cache scheduler 340, a cache interconnect 311, and a plurality of cache monitors 326, 328, and 330 for monitoring the performance of L2 cache 312, 318, and 324, respectively. Cache interconnect 311 comprises an interconnect or bus with associated logic for maintaining coherency between main memory 344 and L2 cache 312, 318, and 324. As described below in more detail, the cache scheduler 340 comprises logic configured to monitor processor and cache performance and manage task scheduling to the processor clusters 302, 304, and 306 according to power and performance requirements of the system 300. As illustrated in FIG. 3, the cache controller 301 may include and/or control the shared cached 350.

Additionally, system 300 includes a processor controller 352 coupled to the plurality of processor clusters 302, 304, and 306. The processor controller 352 may comprise a processor core scheduler 354 and a plurality of processor monitors 362, 364, and 366 for monitoring the performance of the processor cores of the processor clusters 302, 304, and 306, respectively. As described below in more detail, processor core scheduler 354 comprises logic configured to monitor processor, and optionally cache, performance and manage task scheduling to the processor clusters 302, 304, and 306 according to power and performance requirements of the system 300.

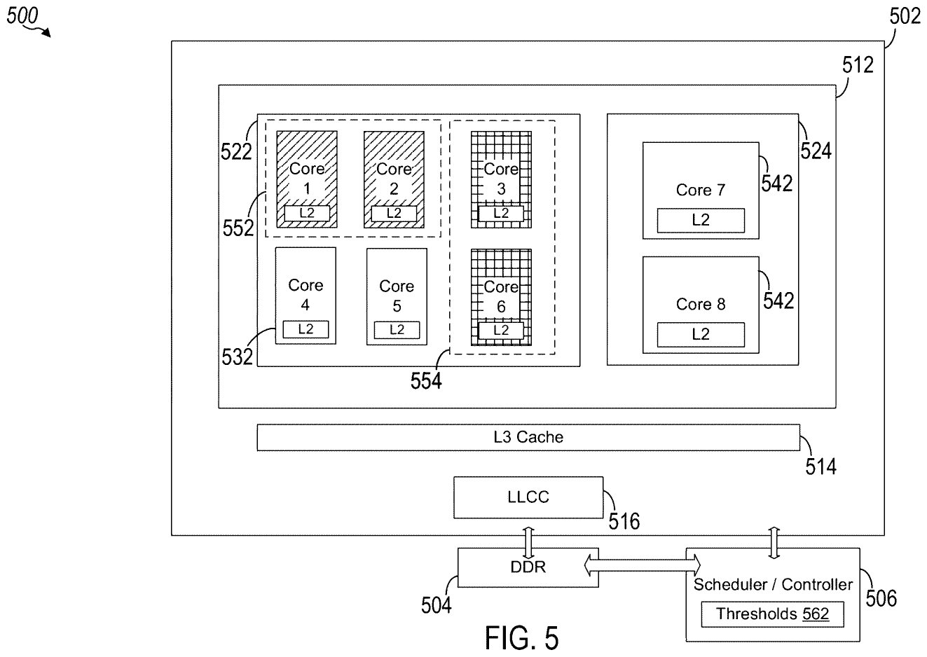

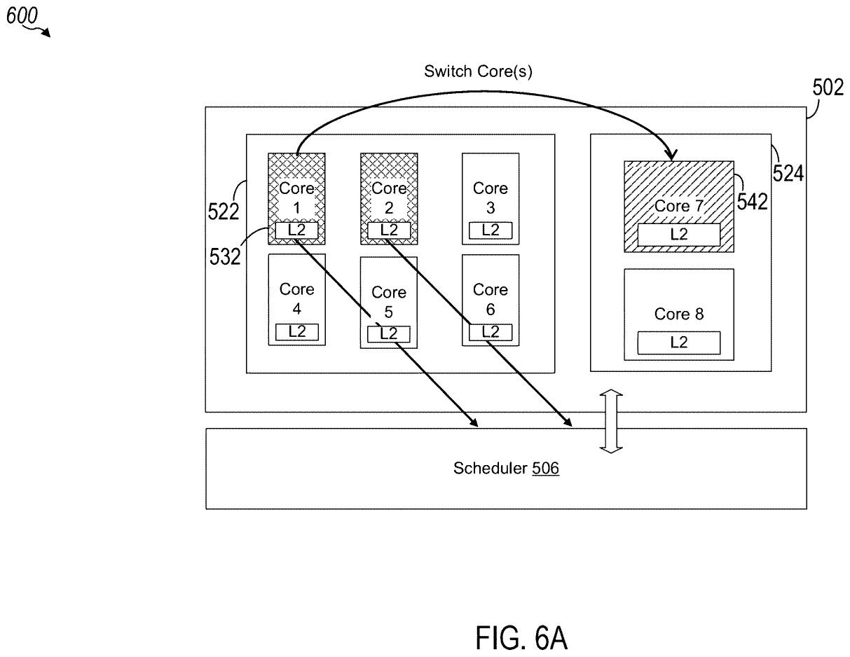

FIG. 4 is a flow chart illustrating a method for an enhanced processing core scheduling scheme for scheduling cores based on cache miss rate information according to some embodiments of the disclosure. In some implementations, the method may be performed by processor 134 of FIG. 1, application processor 230 of FIG. 2, system 300 or processor core scheduler 354 of FIG. 3, or processing system 502 or scheduler 506 of FIG. 5.

A method 400 includes, at block 402, determining core usage information. For example, a scheduler of a processing device or system (e.g., a multiple core processing device, such as one with a big. LITTLE architecture) may obtain (e.g., determine, detect, or receive) information indicating core usage information, such as core CPU usage information. The core usage information may also be referred to as core workload information and may include or correspond to one or more of IPC (Instruction per Clock) information, MIPS (Million Instruction per second) information, frequency level information, CPU active duration information (e.g., time or percentage), or any combination thereof.

The method 400 includes, at block 404, determining cache miss rate information. To illustrate the scheduler may obtain (e.g., determine, detect, or receive) information indicating cache miss rate information, such as dedicated CPU cache miss rate information (e.g., L2 cache), shared CPU cache miss rate information (e.g., L3 cache and/or LLCC), or a combination thereof. The cache miss rate information may also be referred to as cache workload information and may include or correspond to one or more of cache misses per 1000 instructions (MPKI) information, cache accesses per 1000 instructions (APKI) information, cache miss rate information (e.g., MPKI divided by APKI), CPU stall time information, CPU stall ratio information, CPU stalls due to cache miss information, million cycles per second (MCPS) information, or any combination thereof. The MCPS information may be indicative of an amount of CPU stalls due to cache latency.

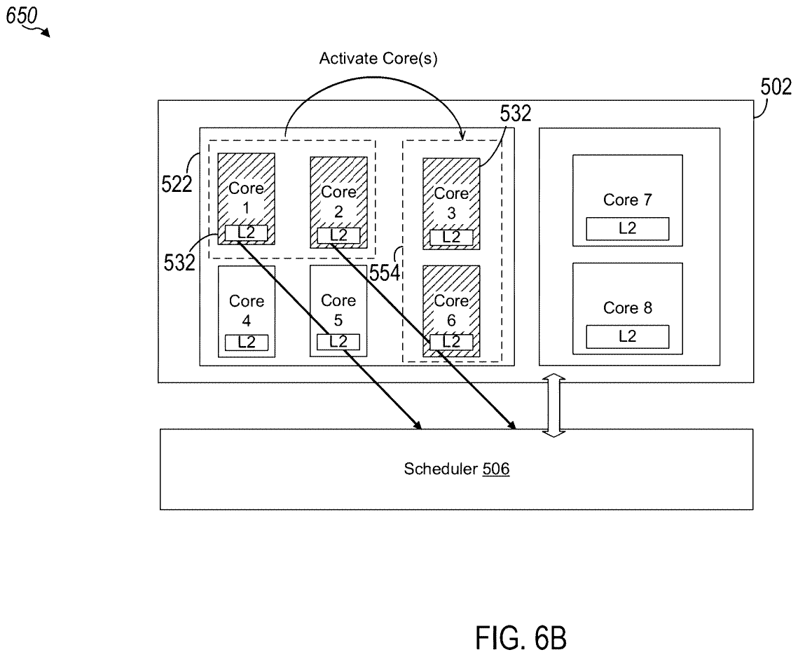

The method 400 includes, at block 406, determining a CPU bottleneck and cause. To illustrate the scheduler may determine if there is a CPU bottleneck, such as a bottleneck due to CPU workload/latency or cache workload/latency information based on the core usage information and the cache miss rate information, and what the bottleneck or bottlenecks are. The scheduler may perform different scheduling actions based on the determination of a bottleneck or bottlenecks, or based on a determination of no bottleneck. Diagrams of such scheduling actions are also further described with reference to FIGS. 6A and 6B.

As illustrated in FIG. 4, the scheduler may use one or more conditions, such as one or more thresholds to determine the bottleneck. For example, the scheduler may compare the cache miss rate information to a corresponding threshold to determine a cache related bottleneck. As another example, the scheduler may compare the core usage information to a corresponding threshold to determine a CPU related bottleneck.

The method 400 includes, at blocks 408-412, actions by the scheduler in response to the bottleneck determination. Responsive to the scheduler determining a CPU and cache bottleneck, at block 408, the method includes switching at least one active core of a first type to at least one core of a second type, such as with a larger and/or more responsive cache. For example, the scheduler may switch one or more silver cores with smaller caches to a gold core with a larger cache to resolve a cache bottleneck and a CPU bottleneck. The core switching can resolve the CPU workload due to cache miss rate or latency more efficiently than bringing on additional smaller more efficient cores that have smaller caches.

Responsive to the scheduler determining a CPU bottleneck and no cache bottleneck, at block 410, the method includes activating at least one additional core of a first type in addition to a currently active core or cores of the first type. For example, the scheduler may activate or bring one or more additional silver cores online to add additional processing resources to resolve a CPU bottleneck that is not due to cache miss or cache latency issues. The additional cores may be inactive cores, paused cores, or a combination thereof. The addition of increased smaller cores can resolve the bottleneck more efficiently than bringing on larger cores or switching cores.

Responsive to the scheduler determining no bottleneck (or at least no CPU bottleneck), at block 412, the method includes maintaining the currently active cores. For example, the scheduler may not activate or bring one or more additional cores of a current core type or bring on other core types. Alternatively, if the workload is low enough, if the cache miss rate is low enough or both, such as less than a corresponding second thresholds, the scheduler may reduce a core count and/or migrate tasks from higher cache cores to lower cache cores to conserve power. The reduction of cores or switching of cores at lower workloads and miss rates may conserve power without impacting performance or impacting performance in a perceptible way by the user.

FIG. 5 is a block diagram 500 illustrating a processing system architecture for the enhanced processing core scheduling scheme described herein according to some embodiments of the disclosure. In FIG. 5, a processing system 502 is illustrated. The processing system 502 is coupled to DDR 504 and a scheduler 506.

The processing system 502 includes one or more processing cores 512, each with their own dedicated cache, and includes a shared cache for the one or more processing cores 512. The processing cores 512 may include multiple types of processing cores and may be arranged into clusters of similar types of processing cores. The different clusters and/or types of processing cores may be of different sizes for handling different workloads and consume different amounts of power. Additionally, the different types of processing cores may have different amount of dedicated cache, such as L2 cache.

The one or more processing cores 512 may include a first cluster of cores 522 (e.g., silver cores) and a second cluster of cores 524 (e.g., gold cores). The first cluster of cores 522 includes first cluster cores 532 and the second cluster of cores 524 includes second cluster cores 542. The shared cache includes L3 cache 514 and LLCC 516. In the example of FIG. 5, the first cluster cores 532 of the first cluster of cores 522 have less cache than the second cluster cores 542 of the second cluster of cores 524. Additionally, in some implementations, a particular core of cluster may also have more cache than cores of a cluster, such as a silver plus core, gold plus core, prime core, etc. To illustrate, a particular core of the first cluster cores 532 may have more L2 cache than the other cores of the first cluster cores 532 of the first cluster of cores 522.

The DDR may include or correspond to the main memory 344 of FIG. 3, and the scheduler 506 may include or correspond to the cache controller 301, the processor controller 352, or both, of FIG. 3. To illustrate, the scheduler 506 may include or correspond to the processor core scheduler 354. The scheduler 506 may include or correspond to logic (e.g., core control logic) configured to perform core scheduling and control operations, such as the enhanced processing core scheduling scheme operations described with reference to FIG. 4. For example, the scheduler 506 may be configured to receive the core usage information and the cache miss rate information and determine which cores to schedule, that is which cores are active. To illustrate, the scheduler 506 may receive the core usage information from the cores or a processing core controller or scheduler as illustrated in FIG. 3, and the scheduler 506 may receive the cache miss rate information from the cores (e.g., L2 cache thereof) or a cache controller or scheduler as illustrated in FIG. 3. The scheduler 506 may compare this information on a per core basis to one or more corresponding thresholds 562 to determine whether to adjust the active cores, such as described with reference to FIG. 4. The thresholds 562 may include one or more core workload thresholds, such as a core busy or core up threshold and a core not busy or core down threshold, one or more cache workload thresholds, such as a cache busy or cache bottleneck threshold and a cache not busy or no bottleneck threshold.

At various times during operation, the processing system 502 may have cores which are at different states or status, such as active, inactive, paused, etc. In the example of FIG. 5, the processing system 502 has active cores 552 and inactive cores 554. To illustrate, a portion of the first cluster cores 532 are active and another portion of the first cluster cores 532 are paused. The other cores may be inactive or paused in some implementations. As described above and with reference to FIG. 4, the scheduler 506 performs one or more operations to determine a bottleneck and to resolve the bottleneck, such as one or more determinations or comparisons using one or more of the thresholds 562. The scheduler 506 may adjust the status the cores to adjust workload and power consumption, such as of activate, unpause, deactivate, etc., one or more cores. The scheduler 506 may adjust the cores as illustrated in FIGS. 6A and 6B and as described further herein.

FIGS. 6A and 6B are each a block diagram illustrating enhanced processing core scheduling scheme operations for the processing system architecture of FIG. 5, processing system 502, according to some embodiments of the disclosure.

Referring to FIG. 6A, FIG. 6A depicts an example of core switching operations according to some embodiments of the disclosure. For example, the scheduler 506 (e.g., a cache usage and miss rate monitor thereof) may determine a cache related bottleneck for one or more processor cores of the processing system 502 and may determine to switch from a lower cache core or cores to a higher cache core or cores. As illustrated in the example of FIG. 6A, the scheduler 506 switches from two silver cores to a single gold core by deactivating cores 1 and 2 and activating core 7. The scheduler 506 may determine to switch from lower cache cores to a higher cache core based on received core usage information and cache miss rate information from cores 1 and 2 indicating a CPU bottleneck caused by a cache bottleneck. For example, the core usage information and the cache miss rate information may be greater than corresponding thresholds, such as a core busy threshold and a cache miss threshold.

Switching from two silver cores to a single gold core may reduce power and offer performance benefits (e.g., increased IPC) as compared to bringing on or reactivating two additional silver cores to reduce the cache bottleneck. To illustrate, in some implementations the single gold core (e.g., core 7) may have the same amount of L2 cache or more L2 cache than four silver cores (e.g., cores 1-4).

Referring to FIG. 6B, FIG. 6B depicts an example of core activation operations according to some embodiments of the disclosure. For example, the scheduler 506 (e.g., a cache usage and miss rate monitor thereof) may determine a CPU related bottleneck for one or more processor cores of the processing system 502 that is not due to a cache related bottleneck (e.g., a CPU bottleneck with low or acceptable cache miss rate) and may determine to activate an inactive or paused lower cache core or cores. As illustrated in the example of FIG. 6B, the scheduler 506 activates two additional (e.g., paused) silver cores, cores 3 and 5, in addition to the two currently active silver cores, cores 1 and 2.

The scheduler 506 may determine to add the additional lower cache cores based on received core usage information and cache miss rate information from cores 1 and 2 indicating a CPU bottleneck that is not caused by a cache bottleneck. For example, the core usage information may be greater than a corresponding threshold, such as a core busy threshold, and the cache miss rate information may be less than a cache miss threshold.

Adding the two additional silver cores may reduce power and offer performance benefits as compared migrating the tasks to two or more larger gold cores. To illustrate, in some implementations the four silver cores (e.g., cores 1-4) may have a combined power consumption which is less than a single gold core (e.g., core 7) or multiple gold cores (e.g., cores 7 and 8).

Although the aspects described herein include adding more lower cache, silver, or little cores, in other implementations, the system (e.g., scheduler thereof) may reduce cores when core utilization drops below a threshold amount as indicated by the core workload information or may add more higher cache, gold, or big cores when higher cache or gold cores are already in use and when core utilization and cache miss rate drop increase above corresponding threshold amounts as indicated by the core workload information and cache miss information.

Additionally, although the aspects described herein include switching from lower cache, silver, or little cores to higher cache, gold, or big cores, in other implementations, the system (e.g., scheduler thereof) may switch from higher cache, gold, or big cores to lower cache, silver, or little cores when core utilization and cache miss rate drop below corresponding threshold amounts as indicated by the core workload information and cache miss information.

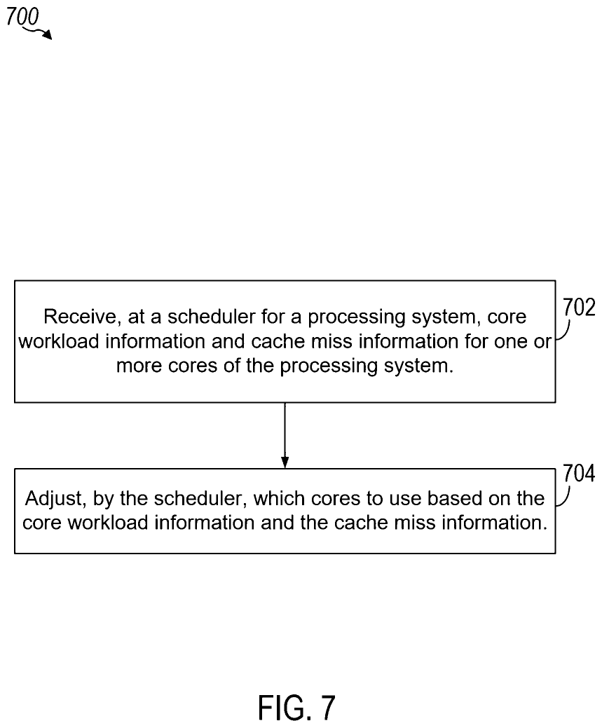

FIG. 7 is a flow chart illustrating a method 700 for an enhanced processing core scheduling scheme for determining active cores based on cache miss rate information by a multiple processing core processing system according to some embodiments of the disclosure. In some implementations, the method may be performed by controller 130 of memory system 110 of FIG. 1, storage system 250 of FIG. 2, system 300 or processor core scheduler 354 of FIG. 3, or processing system 502 or scheduler 506 of FIG. 5.

Method 700 includes, at block 702, receiving, by the scheduler for a processing system that includes multiple processing cores, core workload information and cache miss information for one or more cores of the processing system. For example, the processor core scheduler 354 or the scheduler 506 may determine or receive information indicating core workload and information indicating cache miss rate for one or more active cores of the processing system. To illustrate, the processor core schedules 354 may receive cache workload information for a particular processor core from a corresponding cache monitor or processor monitor, and the may receive core workload information for the particular processor core from the corresponding processor monitor. As another illustration, the scheduler 506 may receive cache workload information and core workload information from the processing system 502, such as from cores and caches thereof.

At block 704, method 700 includes adjusting, by the scheduler, which cores to use based on the core workload information and the cache miss information. For example, the scheduler may adjust which cores are active, paused, and/or off based on the core workload information and the cache miss information. To illustrate, the processor core scheduler 354 or the scheduler 506 may compare the core workload information and the cache miss information to corresponding thresholds, such as thresholds 562, to determine which cores to use and then either activate additional cores, deactivate cores, switch cores (e.g., migrate workload from at least one active core to at least one other paused or inactive core and reactive the previously active core(s)), and/or maintain the current active cores based on the determination, as described above with reference to FIGS. 4-6B. As an illustrative, example, the scheduler 506 may compare core workload information to a core workload threshold (e.g., core busy threshold) of the thresholds 562 and may compare cache miss rate information to a cache miss rate threshold of the thresholds 562.

The device (e.g., such as a processor, a processing system, or a device) may execute additional blocks (or the device may be configured further to perform additional operations) in other implementations. For example, the device (e.g., network node 105 or UE 115) may perform one or more operations as described with reference to FIGS. 3-8. As another example, the device may perform one or more aspects as described above with reference to FIGS. 3-7 or one or more aspects as presented below.

In a first aspect, a device includes: a processing system; and a memory coupled to the processing system, wherein the processing system is configured to cause the device to: receive core workload information and cache miss information for one or more cores of the processing system; and adjust which cores to use based on the core workload information and the cache miss information.

In a second aspect, alone or in combination with the first aspect, the core workload information indicates core usage information per core.

In a third aspect, alone or in combination with the first or second aspects, the core usage information includes per core information for one or more of Instruction per Clock (IPC) information, Million Instruction per second (MIPS) information, frequency level information, CPU active duration information, or any combination thereof.

In a fourth aspect, alone or in combination with one or more of the above aspects, the cache miss information indicates cache miss rate information.

In a fifth aspect, alone or in combination with one or more of the above aspects, the cache miss rate information includes dedicated CPU cache miss rate information per core, shared CPU cache miss rate information, or a combination thereof.

In a sixth aspect, alone or in combination with one or more of the above aspects, the dedicated CPU cache rate miss information include level 2 (L2) cache miss rate information, and wherein the shared CPU cache miss rate information includes level 3 (L3) cache miss rate information, last level (LL) cache miss rate information, or a combination thereof.

In a seventh aspect, alone or in combination with one or more of the above aspects, the cache miss rate information includes one or more of cache misses per 1000 instructions (MPKI) information, cache accesses per 1000 instructions (APKI) information, cache miss rate percentage information, CPU stall time information, CPU stall ratio information, or million cycles per second (MCPS) information.

In an eighth aspect, alone or in combination with one or more of the above aspects, the processing system configured to adjust which cores to use includes to:
determine whether to adjust a core status of at least one core of the processing system based on the core workload information, the cache miss information, or both.

In a ninth aspect, alone or in combination with one or more of the above aspects, the processing system configured to adjust which cores to use includes to: compare the core workload information to a core workload threshold; and compare the cache miss information to a cache miss rate threshold.

In a tenth aspect, alone or in combination with one or more of the above aspects, the processing system configured to adjust which cores to use includes to: compare the core workload information to a core workload threshold; and compare the cache miss information to a cache miss rate threshold based on a result of the comparison of the core workload information to the core workload threshold.

In an eleventh aspect, the processing system configured to adjust which cores to use includes to: switch from a core with a lower amount of dedicated cache to a core with a higher amount of dedicated cache.

In a twelfth aspect, the processing system configured to switch cores includes to: activate a paused core or an inactive core with a first amount of cache; migrate tasks from an active core with a second amount of cache, to the paused core or the inactive core, wherein the second amount of cache is less than the first amount of cache.

In a thirteenth aspect, alone or in combination with one or more of the above aspects, the processing system configured to adjust which cores to use includes to: activate one or more paused cores, inactive cores, or both.

In a fourteenth aspect, alone or in combination with one or more of the above aspects, the processing system configured to adjust which cores to use includes to: activate a paused core or an inactive core of a same type as a currently active core.

In a fifteenth aspect, alone or in combination with one or more of the above aspects, the processing system has a big. LITTLE architecture.

In a sixteenth aspect, alone or in combination with one or more of the above aspects, the processing system has multiple types of cores, including a first type and a second type different from the first type.

In a seventeenth aspect, alone or in combination with one or more of the above aspects, the first type corresponds to a silver core and the second type corresponds to a gold core.

In an eighteenth aspect, alone or in combination with one or more of the above aspects, the processing system is further configured to: receive second core workload information and second cache miss information for the one or more cores of the processing system; and determine to not adjust core status based on the second core workload information not satisfying a core workload condition and the second cache miss information not satisfying a cache miss condition.

In a nineteenth aspect, alone or in combination with one or more of the above aspects, the at processing system configured to adjust which cores to use includes to: determine to activate one or more additional cores based on the core workload information satisfying a core workload condition and based on the cache miss information not satisfying a cache miss rate condition.

In a twentieth aspect, alone or in combination with one or more of the above aspects, the processing system configured to adjust which cores to use includes to: determine to switch cores based on the core workload information satisfying a core workload threshold and based on the cache miss information satisfying a cache miss rate threshold.

In a twenty-first aspect, alone or in combination with one or more of the above aspects, the processing system is further configured to: determine a CPU bottleneck based on the core workload information and core workload threshold information; and responsive to determining the CPU bottleneck, determine a cause of the CPU bottleneck based the cache miss information and a cache miss rate threshold information.

In a twenty-second aspect, alone or in combination with one or more of the above aspects, the processing system configured to determine the CPU bottleneck includes to compare CPU MIPS information to a CPU MIPS threshold, and wherein the processing system configured to determine the cause of the CPU bottleneck includes to compare L2 cache miss information to a L2 cache miss rate threshold.

In a twenty-third aspect, alone or in combination with one or more of the above aspects, the processing system is configured to adjust which cores to use includes to: determine a current amount of L2 cache of currently active cores; and determine whether one or more cores with more L2 cache than the current amount of L2 cache are available.

In a twenty-fourth aspect, a method includes: receiving core workload information and cache miss information for one or more cores of a processing system; and adjusting which cores of the processing system to use based on the core workload information and the cache miss information.

In a twenty-fifth aspect, a wireless communication device includes: a wireless transceiver; a processing system; and a memory coupled to the processing system, wherein the processing system is configured to cause the device to: receive core workload information and cache miss information for one or more cores of the processing system; and adjust which cores to use based on the core workload information and the cache miss information.

In a twenty-sixth aspect, a device includes: a processing system including multiple cores and a core controller; and a memory coupled to the processing system, wherein the core controller is configured to cause the processing system to: receive core workload information and cache miss information for one or more cores of the processing system; and adjust which cores to use based on the core workload information and the cache miss information.

In a twenty-seventh aspect, an apparatus includes: means for receiving core workload information and cache miss information for one or more cores of a processing system; and means for adjusting which cores of the one or more cores to use based on the core workload information and the cache miss information.

In a twenty-eighth aspect, a non-transitory computer-readable medium includes: program code executable by a computer for causing the computer to receive core workload information and cache miss information for one or more cores of the processing system; and program code executable by a computer for causing the computer to adjust which cores to use.

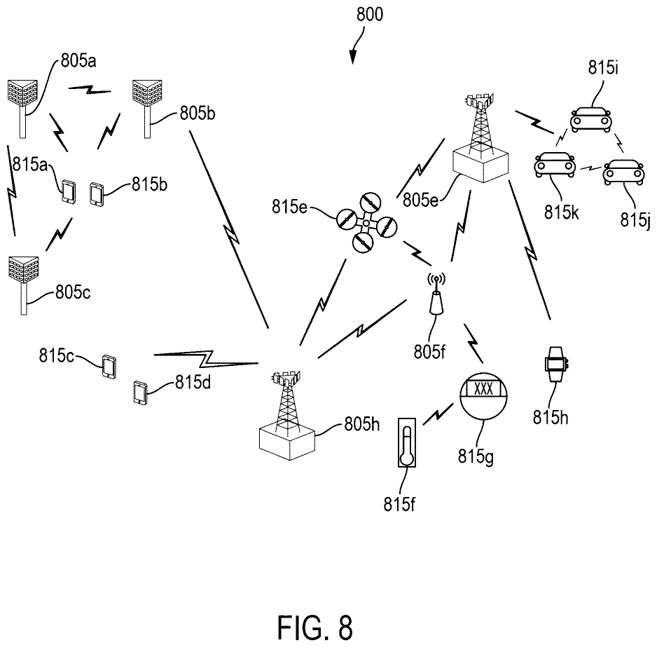

Operations of method 400 or method 700, and the corresponding aspects described above, may be performed by a user equipment (UE), such as a UE described with reference to FIG. 8. For example, example operations (also referred to as “blocks”) of method 400 or method 700 may enable UE 815 (e.g., a wireless communication device) to support an enhanced write buffer flush scheme for writing data to main storage capable of storing multiple bits of data per cell with improved throughput by optimizing available contiguous memory space in the write buffer after flush operations.

FIG. 8 is a block diagram illustrating details of an example wireless communication system according to one or more aspects. The wireless communication system may include wireless network 800. Wireless network 800 may, for example, include a 5G wireless network. As appreciated by those skilled in the art, components appearing in FIG. 8 are likely to have related counterparts in other network arrangements including, for example, cellular-style network arrangements and non-cellular-style-network arrangements (e.g., device to device or peer to peer or ad hoc network arrangements, etc.).

Wireless network 800 illustrated in FIG. 8 includes a number of base stations 805 and other network entities. A base station may be a station that communicates with the UEs and may also be referred to as an evolved node B (eNB), a next generation eNB (gNB), an access point, and the like. Each base station 805 may provide communication coverage for a particular geographic area. In 3GPP, the term “cell” may refer to this particular geographic coverage area of a base station or a base station subsystem serving the coverage area, depending on the context in which the term is used. In implementations of wireless network 800 herein, base stations 805 may be associated with a same operator or different operators (e.g., wireless network 800 may include a plurality of operator wireless networks). Additionally, in implementations of wireless network 800 herein, base station 805 may provide wireless communications using one or more of the same frequencies (e.g., one or more frequency bands in licensed spectrum, unlicensed spectrum, or a combination thereof) as a neighboring cell. In some examples, an individual base station 805 or UE 815 may be operated by more than one network operating entity. In some other examples, each base station 805 and UE 815 may be operated by a single network operating entity.

A base station may provide communication coverage for a macro cell or a small cell, such as a pico cell or a femto cell, or other types of cell. A macro cell generally covers a relatively large geographic area (e.g., several kilometers in radius) and may allow unrestricted access by UEs with service subscriptions with the network provider. A small cell, such as a pico cell, would generally cover a relatively smaller geographic area and may allow unrestricted access by UEs with service subscriptions with the network provider. A small cell, such as a femto cell, would also generally cover a relatively small geographic area (e.g., a home) and, in addition to unrestricted access, may also provide restricted access by UEs having an association with the femto cell (e.g., UEs in a closed subscriber group (CSG), UEs for users in the home, and the like). A base station for a macro cell may be referred to as a macro base station. A base station for a small cell may be referred to as a small cell base station, a pico base station, a femto base station or a home base station. In the example shown in FIG. 8, base stations 805d and 805e are regular macro base stations, while base stations 805a-805c are macro base stations enabled with one of 3 dimension (3D), full dimension (FD), or massive MIMO. Base stations 805a-805c take advantage of their higher dimension MIMO capabilities to exploit 3D beamforming in both elevation and azimuth beamforming to increase coverage and capacity. Base station 805f is a small cell base station which may be a home node or portable access point. A base station may support one or multiple (e.g., two, three, four, and the like) cells.

Wireless network 800 may support synchronous or asynchronous operation. For synchronous operation, the base stations may have similar frame timing, and transmissions from different base stations may be approximately aligned in time. For asynchronous operation, the base stations may have different frame timing, and transmissions from different base stations may not be aligned in time. In some scenarios, networks may be enabled or configured to handle dynamic switching between synchronous or asynchronous operations.

UEs 815 are dispersed throughout the wireless network 800, and each UE may be stationary or mobile. It should be appreciated that, although a mobile apparatus is commonly referred to as a UE in standards and specifications promulgated by the 3GPP, such apparatus may additionally or otherwise be referred to by those skilled in the art as a mobile station (MS), a subscriber station, a mobile unit, a subscriber unit, a wireless unit, a remote unit, a mobile device, a wireless device, a wireless communications device, a remote device, a mobile subscriber station, an access terminal (AT), a mobile terminal, a wireless terminal, a remote terminal, a handset, a terminal, a user agent, a mobile client, a client, a gaming device, an augmented reality device, vehicular component, vehicular device, or vehicular module, or some other suitable terminology. Within the present document, a “mobile” apparatus or UE need not necessarily have a capability to move, and may be stationary. Some non-limiting examples of a mobile apparatus, such as may include implementations of one or more of UEs 815, include a mobile, a cellular (cell) phone, a smart phone, a session initiation protocol (SIP) phone, a wireless local loop (WLL) station, a laptop, a personal computer (PC), a notebook, a netbook, a smart book, a tablet, and a personal digital assistant (PDA). A mobile apparatus may additionally be an IoT or “Internet of everything” (IoE) device such as an automotive or other transportation vehicle, a satellite radio, a global positioning system (GPS) device, a global navigation satellite system (GNSS) device, a logistics controller, a flying device, a smart energy or security device, a solar panel or solar array, municipal lighting, water, or other infrastructure; industrial automation and enterprise devices; consumer and wearable devices, such as eyewear, a wearable camera, a smart watch, a health or fitness tracker, a mammal implantable device, gesture tracking device, medical device, a digital audio player (e.g., MP3 player), a camera, a game console, etc.; and digital home or smart home devices such as a home audio, video, and multimedia device, an appliance, a sensor, a vending machine, intelligent lighting, a home security system, a smart meter, etc. In one aspect, a UE may be a device that includes a Universal Integrated Circuit Card (UICC). In another aspect, a UE may be a device that does not include a UICC. In some aspects, UEs that do not include UICCs may also be referred to as IoE devices. UEs 815a-815d of the implementation illustrated in FIG. 8 are examples of mobile smart phone-type devices accessing wireless network 800. A UE may also be a machine specifically configured for connected communication, including machine type communication (MTC), enhanced MTC (eMTC), narrowband IoT (NB-IOT) and the like. UEs 815e-815k illustrated in FIG. 8 are examples of various machines configured for communication that access wireless network 800.

A mobile apparatus, such as UEs 815, may be able to communicate with any type of the base stations, whether macro base stations, pico base stations, femto base stations, relays, and the like. In FIG. 8, a communication link (represented as a lightning bolt) indicates wireless transmissions between a UE and a serving base station, which is a base station designated to serve the UE on the downlink or uplink, or desired transmission between base stations, and backhaul transmissions between base stations. UEs may operate as base stations or other network nodes in some scenarios. Backhaul communication between base stations of wireless network 800 may occur using wired or wireless communication links.

In operation at wireless network 800, base stations 805a-805c serve UEs 815a and 815b using 3D beamforming and coordinated spatial techniques, such as coordinated multipoint (CoMP) or multi-connectivity. Macro base station 805d performs backhaul communications with base stations 805a-805c, as well as small cell, base station 805f. Macro base station 805d also transmits multicast services which are subscribed to and received by UEs 815c and 815d. Such multicast services may include mobile television or stream video, or may include other services for providing community information, such as weather emergencies or alerts, such as Amber alerts or gray alerts.

Wireless network 800 of implementations supports mission critical communications with ultra-reliable and redundant links for mission critical devices, such UE 815e, which is a aeronautical vehicle. Redundant communication links with UE 815e include from macro base stations 805d and 805e, as well as small cell base station 805f. Other machine type devices, such as UE 815f (thermometer), UE 815g (smart meter), and UE 815h (wearable device) may communicate through wireless network 800 either directly with base stations, such as small cell base station 805f, and macro base station 805e, or in multi-hop configurations by communicating with another user device which relays its information to the network, such as UE 815f communicating temperature measurement information to the smart meter, UE 815g, which is then reported to the network through small cell base station 805f. Wireless network 800 may also provide additional network efficiency through dynamic, low-latency TDD communications or low-latency FDD communications, such as in a vehicle-to-vehicle (V2V) mesh network between UEs 815i-815k communicating with macro base station 805e.

In various implementations, the techniques and apparatus may be used for wireless communication networks such as code division multiple access (CDMA) networks, time division multiple access (TDMA) networks, frequency division multiple access (FDMA) networks, orthogonal FDMA (OFDMA) networks, single-carrier FDMA (SC-FDMA) networks, LTE networks, GSM networks, 5th Generation (5G) or new radio (NR) networks (sometimes referred to as “5G NR” networks, systems, or devices), as well as other communications networks. As described herein, the terms “networks” and “systems” may be used interchangeably. A CDMA network, for example, may implement a radio technology such as universal terrestrial radio access (UTRA), cdma2000, and the like. UTRA includes wideband-CDMA (W-CDMA) and low chip rate (LCR). CDMA2000 covers IS-2000, IS-95, and IS-856 standards. A TDMA network may, for example implement a radio technology such as Global System for Mobile Communication (GSM). The 3rd Generation Partnership Project (3GPP) defines standards for the GSM EDGE (enhanced data rates for GSM evolution) radio access network (RAN), also denoted as GERAN. An OFDMA network may implement a radio technology such as evolved UTRA (E-UTRA), Institute of Electrical and Electronics Engineers (IEEE) 802.11, IEEE 802.16, IEEE 802.20, flash-OFDM and the like. UTRA, E-UTRA, and GSM are part of universal mobile telecommunication system (UMTS). In particular, long-term evolution (LTE) is a release of UMTS that uses E-UTRA. The various different network types may use different radio access technologies (RATs) and RANs.

In some implementations, devices of wireless network 800 may include or access a memory system, such as a flash memory system, described above with reference to FIGS. 1-4. As non-limiting examples, UEs 815 may include or correspond to host device 102 of FIGS. 1 and 3, and memory system 110 of FIGS. 1 and 3 may include or correspond to storage devices that are integrated in UEs 815 or that are removably coupled to UEs 815, such as a SSD, a MMC, an eMMC, a RS-MMC, a micro-MMC, a SD card, a mini-SD, a micro-SD, a USB storage device, a UFS device, a CF card, a SM card, or a memory stick. Additionally, or alternatively, base stations 805 may include or correspond to host device 102 of FIGS. 1 and 3, and memory system 110 of FIGS. 1 and 3 may include or correspond to storage devices that are integrated in base stations 805 or that are removably coupled to base stations 805, such as a SSD, a MMC, an eMMC, a RS-MMC, a micro-MMC, a SD card, a mini-SD, a micro-SD, a USB storage device, a UFS device, a CF card, a SM card, or a memory stick.

While aspects and implementations are described in this application by illustration to some examples, those skilled in the art will understand that additional implementations and use cases may come about in many different arrangements and scenarios. Innovations described herein may be implemented across many differing platform types, devices, systems, shapes, sizes, packaging arrangements. For example, implementations or uses may come about via integrated chip implementations or other non-module-component based devices (e.g., end-user devices, vehicles, communication devices, computing devices, industrial equipment, retail devices or purchasing devices, medical devices, AI-enabled devices, etc.). While some examples may or may not be specifically directed to use cases or applications, a wide assortment of applicability of described innovations may occur. Implementations may range from chip-level or modular components to non-modular, non-chip-level implementations and further to aggregated, distributed, or original equipment manufacturer (OEM) devices or systems incorporating one or more described aspects. In some practical settings, devices incorporating described aspects and features may also necessarily include additional components and features for implementation and practice of claimed and described aspects. It is intended that innovations described herein may be practiced in a wide variety of implementations, including both large devices or small devices, chip-level components, multi-component systems (e.g., radio frequency (RF)-chain, communication interface, processor), distributed arrangements, end-user devices, etc. of varying sizes, shapes, and constitution.

Those of skill in the art would understand that information and signals may be represented using any of a variety of different technologies and techniques. For example, data, instructions, commands, information, signals, bits, symbols, and chips that may be referenced throughout the above description may be represented by voltages, currents, electromagnetic waves, magnetic fields or particles, optical fields or particles, or any combination thereof.

Components, the functional blocks, and the modules described herein with respect to FIGS. 1-8 include processors, electronics devices, hardware devices, electronics components, logical circuits, memories, software codes, firmware codes, among other examples, or any combination thereof. Software shall be construed broadly to mean instructions, instruction sets, code, code segments, program code, programs, subprograms, software modules, application, software applications, software packages, routines, subroutines, objects, executables, threads of execution, procedures, and/or functions, among other examples, whether referred to as software, firmware, middleware, microcode, hardware description language or otherwise. In addition, features discussed herein may be implemented via specialized processor circuitry, via executable instructions, or combinations thereof.

Those of skill in the art that one or more blocks (or operations) described with reference to FIGS. 1-5 and 8 may be combined with one or more blocks (or operations) described with reference to another of the figures. For example, one or more blocks (or operations) of FIG. 1 may be combined with one or more blocks (or operations) of FIG. 3. As another example, one or more blocks associated with FIG. 1 may be combined with one or more blocks (or operations) associated with FIG. 4 or 5. Additionally, or alternatively, one or more operations described above with reference to FIGS. 1-3 may be combined with one or more operations described with reference to FIGS. 4-5 or 8. Additionally, or alternatively, one or more operations of methods described herein may be performed in a different order than described. For example, operations of method 600 of FIG. 6 or method 700 of FIG. 7 may be performed out of order or in a different order than shown in FIGS. 6-7.

Those of skill in the art would further appreciate that the various illustrative logical blocks, modules, circuits, and algorithm steps described in connection with the disclosure herein may be implemented as electronic hardware, computer software, or combinations of both. To clearly illustrate this interchangeability of hardware and software, various illustrative components, blocks, modules, circuits, and steps have been described above generally in terms of their functionality. Whether such functionality is implemented as hardware or software depends upon the particular application and design constraints imposed on the overall system. Skilled artisans may implement the described functionality in varying ways for each particular application, but such implementation decisions should not be interpreted as causing a departure from the scope of the present disclosure. Skilled artisans will also readily recognize that the order or combination of components, methods, or interactions that are described herein are merely examples and that the components, methods, or interactions of the various aspects of the present disclosure may be combined or performed in ways other than those illustrated and described herein.

The various illustrative logics, logical blocks, modules, circuits and algorithm processes described in connection with the implementations disclosed herein may be implemented as electronic hardware, computer software, or combinations of both. The interchangeability of hardware and software has been described generally, in terms of functionality, and illustrated in the various illustrative components, blocks, modules, circuits and processes described above. Whether such functionality is implemented in hardware or software depends upon the particular application and design constraints imposed on the overall system.

The hardware and data processing apparatus used to implement the various illustrative logics, logical blocks, modules and circuits described in connection with the aspects disclosed herein may be implemented or performed with a general purpose single- or multi-chip processor, a digital signal processor (DSP), an application specific integrated circuit (ASIC), a field programmable gate array (FPGA) or other programmable logic device, discrete gate or transistor logic, discrete hardware components, or any combination thereof designed to perform the functions described herein. A general-purpose processor may be a microprocessor, or, any conventional processor, controller, microcontroller, or state machine. In some implementations, a processor may be implemented as a combination of computing devices, such as a combination of a DSP and a microprocessor, a plurality of microprocessors, one or more microprocessors in conjunction with a DSP core, or any other such configuration. In some implementations, particular processes and methods may be performed by circuitry that is specific to a given function.

In one or more aspects, the functions described may be implemented in hardware, digital electronic circuitry, computer software, firmware, including the structures disclosed in this specification and their structural equivalents thereof, or in any combination thereof. Implementations of the subject matter described in this specification also may be implemented as one or more computer programs, which is one or more modules of computer program instructions, encoded on a computer storage media for execution by, or to control the operation of, data processing apparatus.

If implemented in software, the functions may be stored on or transmitted over as one or more instructions or code on a computer-readable medium. The processes of a method or algorithm disclosed herein may be implemented in a processor-executable software module which may reside on a computer-readable medium. Computer-readable media includes both computer storage media and communication media including any medium that may be enabled to transfer a computer program from one place to another. A storage media may be any available media that may be accessed by a computer. By way of example, and not limitation, such computer-readable media may include random-access memory (RAM), read-only memory (ROM), electrically erasable programmable read-only memory (EEPROM), CD-ROM or other optical disk storage, magnetic disk storage or other magnetic storage devices, or any other medium that may be used to store desired program code in the form of instructions or data structures and that may be accessed by a computer. Also, any connection may be properly termed a computer-readable medium. Disk and disc, as used herein, includes compact disc (CD), laser disc, optical disc, digital versatile disc (DVD), floppy disk, and Blu-ray disc where disks usually reproduce data magnetically, while discs reproduce data optically with lasers. Combinations of the above should also be included within the scope of computer-readable media. Additionally, the operations of a method or algorithm may reside as one or any combination or set of codes and instructions on a machine readable medium and computer-readable medium, which may be incorporated into a computer program product.

Various modifications to the implementations described in this disclosure may be readily apparent to those skilled in the art, and the generic principles defined herein may be applied to some other implementations without departing from the spirit or scope of this disclosure. Thus, the claims are not intended to be limited to the implementations shown herein, but are to be accorded the widest scope consistent with this disclosure, the principles and the novel features disclosed herein.

Additionally, a person having ordinary skill in the art will readily appreciate, opposing terms such as “upper” and “lower” or “front” and back” or “top” and “bottom” or “forward” and “backward” are sometimes used for ease of describing the figures, and indicate relative positions corresponding to the orientation of the figure on a properly oriented page, and may not reflect the proper orientation of any device as implemented.

Certain features that are described in this specification in the context of separate implementations also may be implemented in combination in a single implementation. Conversely, various features that are described in the context of a single implementation also may be implemented in multiple implementations separately or in any suitable subcombination. Moreover, although features may be described above as acting in certain combinations and even initially claimed as such, one or more features from a claimed combination may in some cases be excised from the combination, and the claimed combination may be directed to a subcombination or variation of a subcombination.

Similarly, while operations are depicted in the drawings in a particular order, this should not be understood as requiring that such operations be performed in the particular order shown or in sequential order, or that all illustrated operations be performed, to achieve desirable results. Further, the drawings may schematically depict one or more example processes in the form of a flow diagram. However, other operations that are not depicted may be incorporated in the example processes that are schematically illustrated. For example, one or more additional operations may be performed before, after, simultaneously, or between any of the illustrated operations. In certain circumstances, multitasking and parallel processing may be advantageous. Moreover, the separation of various system components in the implementations described above should not be understood as requiring such separation in all implementations, and it should be understood that the described program components and systems may generally be integrated together in a single software product or packaged into multiple software products. Additionally, some other implementations are within the scope of the following claims. In some cases, the actions recited in the claims may be performed in a different order and still achieve desirable results.

As used herein, including in the claims, the term “or,” when used in a list of two or more items, means that any one of the listed items may be employed by itself, or any combination of two or more of the listed items may be employed. For example, if a composition is described as containing components A, B, or C, the composition may contain A alone; B alone; C alone; A and B in combination; A and C in combination; B and C in combination; or A, B, and C in combination. Also, as used herein, including in the claims, “or” as used in a list of items prefaced by “at least one of” indicates a disjunctive list such that, for example, a list of “at least one of A, B, or C” means A or B or C or AB or AC or BC or ABC (that is A and B and C) or any of these in any combination thereof. The term “substantially” is defined as largely but not necessarily wholly what is specified (and includes what is specified; for example, substantially 90 degrees includes 90 degrees and substantially parallel includes parallel), as understood by a person of ordinary skill in the art. In any disclosed implementations, the term “substantially” may be substituted with “within [a percentage] of” what is specified, where the percentage includes 0.1, 1, 5, or 10 percent.

The previous description of the disclosure is provided to enable any person skilled in the art to make or use the disclosure. Various modifications to the disclosure will be readily apparent to those skilled in the art, and the generic principles defined herein may be applied to other variations without departing from the spirit or scope of the disclosure. Thus, the disclosure is not intended to be limited to the examples and designs described herein but is to be accorded the widest scope consistent with the principles and novel features disclosed herein.

What is claimed is:

1. A device comprising:
a processing system; and
a memory coupled to the processing system,
wherein the processing system is configured to cause the device to:
receive core workload information and cache miss information for one or more cores of the processing system; and
adjust which cores to use based on the core workload information and the cache miss information.

2. The device of claim 1, wherein the core workload information indicates core usage information per core.

3. The device of claim 2, wherein the core usage information includes per core information for one or more of Instruction per Clock (IPC) information, Million Instruction per second (MIPS) information, frequency level information, CPU active duration information, or any combination thereof.

4. The device of claim 1, wherein the cache miss information indicates cache miss rate information, and wherein the cache miss rate information includes dedicated CPU cache miss rate information per core, shared CPU cache miss rate information, or a combination thereof.

5. The device of claim 4, wherein the dedicated CPU cache miss rate information include level 2 (L2) cache miss rate information, and wherein the shared CPU cache miss rate information includes level 3 (L3) cache miss rate information, last level (LL) cache miss rate information, or a combination thereof.

6. The device of claim 5, wherein the cache miss rate information includes one or more of cache misses per 1000 instructions (MPKI) information, cache accesses per 1000 instructions (APKI) information, cache miss rate percentage information, CPU stall time information, CPU stall ratio information, or million cycles per second (MCPS) information.

7. The device of claim 1, wherein the processing system configured to adjust which cores to use includes to:
determine whether to adjust a core status of at least one core of the processing system based on the core workload information, the cache miss information, or both.

8. The device of claim 1, wherein the processing system configured to adjust which cores to use includes to:
compare the core workload information to a core workload threshold; and
compare the cache miss information to a cache miss rate threshold.

9. The device of claim 1, wherein the processing system configured to adjust which cores to use includes to:
compare the core workload information to a core workload threshold; and
compare the cache miss information to a cache miss rate threshold based on a result of the comparison of the core workload information to the core workload threshold.

10. The device of claim 9, wherein the processing system configured to adjust which cores to use includes to:
switch from a core with a lower amount of dedicated cache to a core with a higher amount of dedicated cache.

11. The device of claim 10, wherein the processing system configured to switch cores includes to:
activate a paused core or an inactive core with a first amount of cache;
migrate tasks from an active core with a second amount of cache, to the paused core or the inactive core, wherein the second amount of cache is less than the first amount of cache; and
deactivate the active core with the second amount of cache.

12. The device of claim 11, wherein the processing system configured to adjust which cores to use includes to:
activate one or more paused cores, inactive cores, or both.

13. The device of claim 12, wherein the processing system configured to adjust which cores to use includes to:
activate a paused core or an inactive core of a same type as a currently active core.

14. The device of claim 11, wherein the processing system is further configured to:
receive second core workload information and second cache miss information for the one or more cores of the processing system; and
determine to not adjust core status based on the second core workload information not satisfying a core workload condition and the second cache miss information not satisfying a cache miss condition.

15. The device of claim 1, wherein the at processing system configured to adjust which cores to use includes to:
determine to activate one or more additional cores based on the core workload information satisfying a core workload condition and based on the cache miss information not satisfying a cache miss rate condition.

16. The device of claim 1, wherein the processing system configured to adjust which cores to use includes to:
determine to switch cores based on the core workload information satisfying a core workload threshold and based on the cache miss information satisfying a cache miss rate threshold.

17. The device of claim 1, wherein the processing system is further configured to:
determine a CPU bottleneck based on the core workload information and core workload threshold information; and
responsive to determining the CPU bottleneck, determine a cause of the CPU bottleneck based the cache miss information and a cache miss rate threshold information.

18. The device of claim 17, wherein the processing system configured to determine the CPU bottleneck includes to compare CPU MIPS information to a CPU MIPS threshold, and wherein the processing system configured to determine the cause of the CPU bottleneck includes to compare L2 cache miss information to a L2 cache miss rate threshold.

19. The device of claim 1, wherein the processing system is configured to adjust which cores to use includes to:
determine a current amount of L2 cache of currently active cores; and
determine whether one or more cores with more L2 cache than the current amount of L2 cache are available.

20. A method comprising:
receiving core workload information and cache miss information for one or more cores of a processing system; and
adjusting which cores of the processing system to use based on the core workload information and the cache miss information.
